(19) United States
(12) Patent Application Publication
(10) Pub. No.: US 2007/0202425 A1
(43) Pub. Date: Aug. 30, 2007

(54) Toner and image forming apparatus

(76) Inventors: Kousuke Satou, Osaka-shi (JP); Naruo Yabe, Osaka-shi (JP)

Correspondence Address: CLARK & BRODY, 1090 VERMONT AVENUE, NW, SUITE 250, WASHINGTON, DC, 20005, US

(21) Appl. No.: 11/710,572

(22) Filed: Feb. 26, 2007

(30) Foreign Application Priority Data
Feb. 27, 2006 (JP) 2006-050314

(51) Int. Cl. G03G 9/08

(52) U.S. Cl. 430/108.2; 430/111.4; 430/123.42

(57) ABSTRACT

Disclosed is a toner used for an image forming apparatus, comprising an organic photoreceptor as a latent image supporting material and a cleaning blade for removing a residual toner on the organic photoreceptor after a transfer process, wherein the friction coefficient between the organic photoreceptor and the toner is from 0.30 to 0.65, the toner contains at least one kind of inorganic fine particles on the surface, and one of the inorganic fine particles is made of silica.

### 1. FIELD OF THE INVENTION

The present invention relates to a toner which is preferably used for copy machines, printers and facsimiles, and an image forming apparatus.

### 2. DESCRIPTION OF RELATED ART

As compared with inorganic photoreceptors such as a selenium-based photoreceptor and an amorphous silicon photoreceptor, organic photoreceptors have a lot of merits such as wide selectivity of materials, excellent environmental suitability and low production cost and are therefore widely used for an electrophotographic photoreceptor. However, there are such defects as low mechanical strength, easy adherence of a foreign body, low chemical durability and deterioration in electrostatic characteristics of a photoreceptor and occurrence of abrasion on a surface of a photoreceptor when a large quantity is printed.

Accordingly, organic photoreceptors are required to have durability against adherence of a foreign body and abrasion on the surface, which occurs by applying a mechanical external force when a toner image formed on the photoreceptor is transferred onto a transfer material such as paper and a residual toner on the photoreceptor is cleaned.

That is, when abrasion resistance is not high enough against contact friction by a means of cleaning or the like and a surface layer of a photoreceptor is abraded in printing in large quantity, linear abrasion appears on the surface of the photoreceptor, and an inorganic external addition agent such as silica as a toner component adheres and thus the surface of the organic photoreceptor is contaminated with a component of an external addition agent, causing such problems as easy occurrence of a dash mark (a small linear black speck) and a rough halftone image.

Therefore, in order to solve the above-described problems, various methods are suggested so as to control a friction coefficient between a toner and a photoreceptor (see, for example, Japanese Unexamined Patent Publications (Kokai) No. 2005-309299, No. 2005-99125, No. 2004-258625, No. 2004-304006, and No. 9-138580). In Japanese Unexamined Patent Publications (Kokai) No. 2005-309299 and No. 2005-99125, in order to control a friction coefficient between a toner and a photoreceptor, a method that regulates a dynamic friction coefficient of a toner by adjusting a roundness of a toner is provided. In Japanese Unexamined Patent Publications (Kokai) No. 2004-258625 and No. 2004-304006, in order to suppress the occurrence of uneven abrasion on a photoreceptor, a method is provided to make a dynamic friction coefficient of a toner, which is susceptible to an external addition agent on a toner surface, a value within a predetermined range. However, for example, in Japanese Unexamined Patent Publication (Kokai) No. 2004-258625, the friction coefficient is measured using a pellet-shaped toner sample, while, in Japanese Unexamined Patent Publication (Kokai) No. 9-138580, a friction coefficient is regulated by a static friction coefficient, not by a dynamic friction coefficient. Therefore, the friction coefficient does not always reflect the state in an actual printer, and there is a problem in abrasion resistance of a photoreceptor in long-term use.

In addition, in an image forming apparatus loaded with an organic photoreceptor drum, silica having a small particle size to improve fluidity of a toner or low resistant titanium oxide to give a polishing effect is used as an external addition agent, resulting in some problems such as occurrence of a dash mark. It is considered that when a toner component containing low resistant titanium oxide adheres onto a surface of an organic photoreceptor drum, electric charge leaks even onto a non-printed part and thus an image of a black speck appears on a blank portion. It is also considered to be a phenomenon that since silica having a small particle size is apt to pass through a cleaning blade, a toner also passes through it along with silica and, with contact pressure of the blade, the toner adheres onto a surface of a photoreceptor.

### SUMMARY OF THE INVENTION

The main object of the present invention is to provide a toner, which can maintain good surface of an organic photoreceptor because of no adherence of the toner component onto the photoreceptor, and also can maintain stable image quality in long-term use.

The present inventors had devoted themselves to the study so as to solve the above problems and found that, by using a toner having a friction coefficient with an organic photoreceptor falling within a predetermined range, a good photoreceptor surface is maintained even in long-term use.

That is, a toner of the present invention is used for an image forming apparatus comprising an organic photoreceptor as a latent image supporting material and a cleaning blade for removing a residual toner on the organic photoreceptor after a transfer process, and the friction coefficient with the organic photoreceptor is from 0.30 to 0.65.

An image forming apparatus of the present invention comprises an organic photoreceptor as a latent image supporting material and a cleaning blade for removing a residual toner on the organic photoreceptor after a transfer process, and a toner having a friction coefficient with the organic photoreceptor from 0.30 to 0.65 is used.

As described above, by regulating the friction coefficient between a toner and an organic photoreceptor is regulated within the above-described range when used for an image forming apparatus comprising an organic photoreceptor and a cleaning blade, the toner component does not adhere onto the surface of the organic photoreceptor, and thus making it possible to maintain good surface of the organic photoreceptor and to output a stable image quality.

### BRIEF DESCRIPTION OF THE DRAWINGS

FIG. 1 is a schematic view showing an image forming apparatus according to an embodiment of the present invention.

FIG. 2 is a schematic view showing an example of an apparatus used for measurement of a friction coefficient according to the present invention.

### DETAILED DESCRIPTION OF PREFERRED EMBODIMENTS

A toner of the present invention will be described below in detail.

A toner of the present invention, as described above, is used for an image forming apparatus equipped with an organic photoreceptor as a latent image supporting material and a process to remove a residual toner on the photoreceptor by a cleaning blade after a transfer process, and has a friction coefficient with the photoreceptor from 0.30 to 0.65.

In case that the friction coefficient between the organic photoreceptor and the toner is less than 0.30, the polishing effect to the photoreceptor is lowered, thereby causing irregularity on the surface of the photoreceptor and occurrence of a dash mark. In case that it exceeds 0.65, the toner easily passes through a cleaning blade and is subjected to contact pressure by the blade so as to adhere onto the surface of the photoreceptor.

A toner of the present invention preferably contains at least one kind of inorganic particles as external addition agents on the toner surface. As the inorganic particle, silica is exemplified.

For setting the friction coefficient with the photoreceptor within the above range, a friction coefficient between silica added as an external addition agent and the organic photoreceptor is preferably from 0.4 to 0.75. That is, since an external addition agent exists on the toner surface, it has a major effect on a friction coefficient with the photoreceptor. Especially, as for silica, it occurs frequently that the rate of covering on the surface of a toner is high as compared with other external addition agents such as titanium oxide. Accordingly, silica could be the greatest factor for determining a friction coefficient with the photoreceptor.

That is, in order to set a friction coefficient between the organic photoreceptor and the toner within the above range, a friction coefficient between silica and the organic photoreceptor is preferably kept within the above range, and therefore a particle size of silica to be used (an average aggregate particle size and the standard deviation), a surface treatment of silica and the amount of silica are preferably adjusted in the range described hereinafter.

The silica is preferably composed of aggregated particles and has the average aggregate size of 30 to 200 nm, and standard deviation of the particle size distribution is 65 nm or less. When the average aggregate size of the aggregated silica particles is less than 30 nm, a friction coefficient between a toner and a photoreceptor increases and thus the toner easily passes through a cleaning blade, resulting in easy adherence to the photoreceptor. On the other hand, when it exceeds 200 nm, a friction coefficient decreases and thus polishing effect to a photoreceptor decreases, thereby causing easy occurrence of a dash mark. Furthermore, it is not preferable that the standard deviation exceeds 65 nm, because in that case particle size distribution becomes broader and thus the ratio of silica having small particle size increases and the friction coefficient increases.

The amount of the silica (aggregated silica particles) to be added to a toner surface is preferably from 0.5 to 2.5% by mass of that of the toner before silica is added. When the total amount of the aggregated silica particles is less than 0.5% by mass, coverage to the toner particles decreases too much and thus the toner charge is overcharged, causing easy charge up. In addition, it is considered that the accumulating ratio at a cleaning blade increases due to decreased fluidity and probability of passing through the blade increases. This brings to adherence of a toner to a photoreceptor. When the total amount of the aggregated silica particles exceeds 2.5% by mass, a friction coefficient between a toner and a photoreceptor increases and thus a toner can easily pass through a cleaning blade, resulting in easy adherence to a photoreceptor.

The friction coefficient between the toner and a photoreceptor is preferably measured under the conditions resembling to those in the actual image forming apparatus. For example, a toner containing an external addition agent such as silica is placed on a flat plate in the form of a thin layer, and a photoreceptor is placed on it. Then, predetermined load is applied vertically to the shafts at both ends of the photoreceptor, which is then pulled horizontally with a spring balance to measure a dynamic friction coefficient between the toner and the photoreceptor.

Aggregate silica particles used in the present invention are preferably surface treated with a cyclic silazane. By using the cyclic silazane, silica surface is uniformly treated and preferable charge property and fluidity can be maintained.

An example of a cyclic silazane compound is represented by the following formula (I):

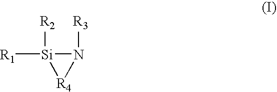

wherein R₁ and R₂ have at least one selected from hydrogen atom, halogen atom, alkyl group, alkoxy group and aryloxy group, R₃ represents hydrogen atom, —(CH₂)ₙCH₃, —C(O) (CH₂)ₙCH₃, —C(O)NH₂, —C(O)NH(CH₂)ₙCH₃ or —C(O)N [(CH₂)ₙCH₃] (CH₂)ₘCH₃ wherein n and m represent an integer of 0 to 3, R₄ represents —[(CH₂)ₐ(CHX)_{b}(CHY)_{c}]— wherein X, Y and Z have at least one group selected from hydrogen atom, halogen atom, alkyl, alkoxy group and aryloxy group, and a, b and c represent an integer of 0 to 6, which satisfy the condition that a+b+c equals to an integer of 2 to 6. Metal oxide, such as silica, which is surface treated with a cyclic silazane is disclosed in Japanese Unexamined Patent Publication (Kokai) No. 10-330115.

### (Method for Producing Toner)

A toner used for the present invention is obtained by adding a release agent, a colorant and a charge control agent to a predetermined amount of a binder resin and, followed by mixing with stirring it in a mixer such as a Henschell mixer. The resulting mixture is melt-kneaded using a biaxial extruder or the like, cooled and ground by a grinder such as a hammer mill and a jet mill. Then, the ground powder is classified using a classifier such as a wind power classifier to obtain toner particles having a predetermined particle size. A predetermined amount of the external addition agent is added to the resulting toner particles, followed by mixing with stirring in a mixer such as a Henschell mixer to produce a toner.

### (Binder Resin)

The binder resin is not specifically limited. Examples thereof include thermoplastic resins such as styrene-acryl resin, polyester resin, polyacryl-based resin, polyethylene-based resin, polypropylene-based resin, vinyl chloride-based resin, polyamide-based resin, polyurethane-based resin, polyvinyl alcohol-based resin, vinyl ether-based resin, N-vinyl-based resin and styrene-butadiene resin. If need arises, these resin and other resin could be used in combination, or two or more resins among these resins could be used.

Examples of the monomer serving as a base for the styrene-acryl resin include styrene derivatives such as styrene, α-methylstyrene, p-methylstyrene, p-t-butylstyrene, p-chlorostyrene and hydroxystyrene; and (meth)acrylate esters such as methacrylic acid, methyl (meth)acrylate, ethyl (meth)acrylate, propyl (meth)acrylate, butyl(meth)acrylate, glycidyl (meth)acrylate, methoxyethyl (meth)acrylate, propoxyethyl (meth)acrylate, methoxydiethylene glycol (meth)acrylate, ethoxydiethylene glycol (meth)acrylate, benzyl (meth)acrylate, cyclohexyl (meth)acrylate, tetrahydrofurfuryl (meth)acrylate, (metha)acrylonitrile, (metha)acrylamide, N-methylol(metha)acrylamide, ethylene glycol di(meth)acrylate, 1,3-butylene glycol di(meth)acrylate, 1,4-butanediol (meth)acrylate and trimethylolethane tri(meth)acrylate.

A mixture of the monomers are polymerized by a given method such as solution, bulk, emulsion or suspension polymerization, and the resulting polymer is served as a binder resin used for the present invention. In the polymerization, a known polymerization initiator such as acetyl peroxide, decanoyl peroxide, lauroyl peroxide, benzoyl peroxide, azobisisobutylonitrile, 2,2′-azobis-2,4-dimethylbaleronitrile, 2,2′-azobis-4-methoxy-2,4-dimethylbaleronitrile can be used. The polymerization initiator is preferably used in an amount within a range from 0.1 to 15% by mass based on the total weight of the monomers.

The polyester resin is mainly obtained by condensation polymerization of polyhydric carboxylic acids and polyhydric alcohols. Examples of polyhydric carboxylic acids include an aromatic polyhydric carboxylic acid such as phthalic acid, isophthalic acid, terephthalic acid, succinic acid, 1,2,4-benzenetricarboxylic acid, 2,5,7-naphthalenetricarboxylic acid, 1,2,4-naphthalenetricarboxylic acid or pyromellitic acid; an aliphatic dicarboxylic acids such as maleic acid, fumaric acid, succinic acid, adipinic acid, sebacic acid, malonic acid, azelaic acid, mesaconic acid, citraconic acid or glutaconic acid; alicyclic dicarboxylic acids such as cyclohexanedicarboxylic acid and methyl medic acid; and an anhydride and a lower alkyl ester of these carboxylic acids. One or more carboxylic acids are used.

The content of trivalent or higher valent components depends on the degree of crosslinking, and therefore the amount to be added could be adjusted to have the intended degree of crosslinking. Generally, the content of trivalent or higher valent components is preferably 15 mol % or less.

Examples of polyhydric alcohols used for the polyester resin include alkylene glycols such as ethylene glycol, 1,2-propylene glycol, 1,3-propylene glycol, 1,4-butanediol, 1,4-butenediol, neopentyl glycol, 1,5-pentaneglycol and 1,6-hexaneglycol; alkylene etherglycols such as diethylene glycol, triethylene glycol, dipropylene glycol, polyethylene glycol, polypropylene glycol and polytetramethylene glycol; alicyclic polyhydric alcohols such as 1,4-cyclohexanedimethanol and hydrogenated bisphenol A; bisphenols such as bisphenol A, bisphenol F and bisphenol S and alkylene oxide adducts of bisphenols. One or more of them can be used in combination.

For the purpose of adjusting the molecular weight and controlling the reaction, a monocarboxylic acid or a monoalcohol can be used, if necessary. Examples of the monocarboxylic acid include benzoic acid, paraoxybenzoic acid, toluenecarboxylic acid, salicylic acid, acetic acid, propionic acid and stearic acid. Examples of the monoalcohol include benzyl alcohol, toluene-4-methanol and cyclohexane methanol.

The glass transition temperature of the binder resin is preferably in the range from 54 to 62° C. When the glass transition temperature is less than 54° C., the resin could be solidified in a development apparatus or a toner cartridge. On the other hand, when the temperature exceeds 62° C., the toner may not be sufficiently fixed on a transferred material such as paper.

### (Release Agent)

As the release agent, for example, various waxes, synthetic waxes such as Fisher-Tropsch wax and low molecular weight olefin-based resins can be used. Examples of the wax include polyhydric alcohol esters of a fatty acid, higher alcohol esters of a fatty acid, alkylene bisfatty acid amide compounds and natural waxes. Examples of the low molecular weight olefin-based resin include polypropylene, polyethylene and a propylene-ethylene copolymer having a number average molecular weight of 1,000 to 10,000, and preferably 2,000 to 6,000. The content of a release agent is preferably within a range from 0.1 to 10 parts by mass based on 100 parts by mass of a binder resin.

### (Colorant)

In a magnetic toner, the toner color is black due to a magnetic powder, and thereby a colorant is commonly not necessary when used as a black toner, but carbon black such as acetylene black, lamp black and aniline black may be dispersed in toner particles as an additional colorant. The content of the colorant in that case is preferably within a range from 0.1 to 10 parts by mass based on 100 parts by mass of a binder resin.

### (Charge Control Agent)

As the charge control agent, a known charge control agent can be used. Examples of a positive charging charge control agent include nigrosine dyes, nigrosine modified fatty acid, carboxyl group-containing nigrosine dyes modified with fatty acid, quaternary ammonium salts, amine-based compounds and organic metal compounds. Examples of a negative charging charge control agent include metal complexes of oxycarboxylic acid, metal complexes of azo compounds, metal complex dyes and salicylic acid derivatives. The content of a charge control agent is preferably within a range from 0.1 to 10 parts by mass based on 100 parts by mass of a binder resin.

### (Magnetic Powder)

A toner of the present invention is preferably used as a magnetic one-component developer. In case that the toner is a magnetic toner, a magnetic powder is used. Examples of the magnetic powder include known powders, for example, powders of iron such as ferrite and magnetite, ferromagnetic metals such as cobalt and nickel or the alloys or the compounds containing these elements, alloys containing no ferromagnetic element that present ferromagnetism by proper heat treatment, and chromium dioxide.

These magnetic powders are uniformly dispersed in a binder resin in the form of a fine powder having an average particle size from 0.1 to 1 μm, and preferably 0.1 to 0.5 μm. The magnetic powder can be surface treated before use with a surface treatment agent such as a titanium-based coupling agent and a silane-based coupling agent.

The magnetic powder is preferably contained in the toner in an amount within a range from 30 to 60 parts by mass, preferably from 45 to 55 parts by mass. When the amount of the magnetic powder is more than the above, durability of an image density deteriorates and fixation properties tend to drastically deteriorate. When the amount is less than the above range, fog in the durability of an image density deteriorates.

The shape of the magnetic powder used for the present invention is not specifically limited. However, when the magnetic powder contained is not a spherical form, but a polyhedral form having edges (such as octahedron and hexahedron), it is expected that one or plural angles of the magnetic powder are exposed and, when the content of the magnetic powder falls within the range from 40 to 55% by mass, a toner potential accumulated at a blade edge can gradually but effectively be discharged from the edges of the magnetic powder before reaching out to the dielectric breakdown potential of a photoreceptor as a result of a friction electrification between the toner potential and a blade.

For observing the shape of the magnetic powder, if necessary, a transmission electron microscope (TEM) H-700H, H-800 or H-7500 (manufactured by HITACHI LTD.) or a scanning electron microscope (SEM) S-800 or S-4700 (manufactured by HITACHI LTD.) is used, wherein a micrograph is taken in the magnification of 20,000 to 200,000 times and printed in the printing magnification of 1 to 10 times, and the samples can be observed at a given magnification.

### (External Addition Agent)

For adjusting charge control properties and fluidity of a toner, one or more external addition agents can be added in addition to the silica. Example of the external addition agent include inorganic fine powders such as powders of titanium oxide, alumina, zinc oxide, magnesium oxide and calcium carbonate; organic fine powders such as powders of polymethylmethacrylate; and metal salts of fatty acid such as zinc stearate. The amount of the external addition agent to be added is preferably within a range from 0.1 to 5.0% by mass based on toner particle. The mixture of the external addition agent and toner particles can be conducted by using, for example, Henschell mixer, V-type mixer, Tarbra mixer or hybridizer.

The surface of the inorganic fine powder may be untreated, or optionally treaded with a silane coupling agent, aminosilane, silicone oil or a titanate coupling agent so as to hydrophobize the powder or control charge characteristics.

Examples of the silane coupling agent include organoalkoxysilane (for example, methoxytrimethylsilane, dimethoxydimethylsilane, trimethoxymethylsilane and ethoxytrimethylsilane); organochlorosilane (for example, trichloromethylsilane, dichlorodimethylsilane, chlorotrimethylsilane, trichloroethylsilane, dichlorodiethylsilane, chlorotriethylsilane and trichlorophenylsilane); organosilazane (for example, triethylsilazane, tripropylsilazane and triphenylsilazane); organodisilazane (for example, hexamethyldisilazane, hexaethyldisilazane and hexaphenyldisilazane); and other organosilazane. These silane coupling agents can be used alone or in combination. Among these silane coupling agents, organochlorosilane, organosilazane and organodisilazane are preferably used.

Examples of the silicone oil include dimethyl silicone oil, methylphenyl silicone oil, methylhydrogen silicone oil, fluorosilicone oil and modified silicone oil. These oils can be used alone or in combination. If necessary, the silicone oil could be hardened by a crosslinking agent or heat treatment. Among the above silicone oils, dimethyl silicone oil is preferably used.

Examples of the titanate coupling agent include isopropyltriisostearoyl titanate, isopropyltrichromylphenyl titanate and tetraisopropylbis(dioctylphosphite)titanate. They could be used independently or in combination of two or more of them. Among these titanate coupling agents, isopropyltriisostearoyl titanate is preferably used.

The amount of the surface treatment agent to be used is preferably within a range from 0.05 to 20 parts by mass, based on 100 parts by mass of an external addition agent.

### (Image Forming Apparatus)

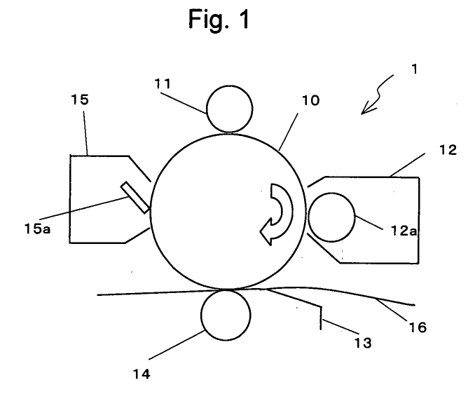

An image forming apparatus according to an embodiment of the present invention is described with reference to the accompanying drawings. FIG. 1 shows a schematic configuration of an image forming apparatus according to the present invention. The image forming apparatus 1 according to an embodiment of the present invention is equipped with an organic photoreceptor drum 10 as a latent image supporting material, a charge roller 11 serving as a contact charging device applying charge voltage by contacting it to the surface of the organic photoreceptor drum 10, an exposure means (not shown) for exposing the surface of the organic photoreceptor drum 10 to form an electrostatic latent image, a development means 12 such as a development sleeve 12a, which adheres a charge toner having predetermined polarity to the electrostatic latent image on the organic photoreceptor drum 10, a transfer device 14 such as a contact transfer roller, which applies a transfer voltage to a transfer material 16 fed/delivered by a feeding/delivering device 13 so as to transfer a toner image onto a transfer material 16, and a cleaning device for a latent image supporting material 15 (a cleaning blade 15a) which collects a non-transferred toner remaining on the latent image supporting material 10.

The organic photoreceptor drum 10 is composed of an electroconductive substrate and a photosensitive layer containing at least a charge generating agent and a charge transferring agent provided on the surface of the substrate. In addition, a protective layer may be formed on the surface of the photosensitive layer.

Examples of the electroconductive substrate include those made of metals such as iron, aluminum and stainless steel, plastic materials on which the above metal is deposited or laminated, and glass coated with aluminum iodide, tin oxide, indium oxide or the like.

As a photosensitive layer, a single-layered type and a multi-layered type are known. In the present invention, either type of organic photoreceptor can be used.

A single-layered electrophotographic photoreceptor is obtained by mixing a known charge generating agent, an electron transferring agent and a binder resin, and a hole transferring agent and other additives according to need, together with an adequate solvent to prepare a dispersion solution, followed by application of the dispersion solution onto an electrocunductive substrate and further drying. The thickness of the photosensitive layer is within a range from 5 to 100 μm, and preferably from 10 to 50 μm.

In case of a multi-layered type photoreceptor, a known charge generating agent and a charge transferring agent (an electron transferring agent or a hole transferring agent) are respectively mixed with an adequate binder resin and a solvent to prepare dispersion solutions, and then the dispersion solutions are applied onto an electroconductive substrate and dried. The thickness of the respective layer after drying is in the range from 0.01 to 5 μm, and preferably from 0.1 to 3 μm in case of the charge generating layer, and in the range from 2 to 100 μm, and preferably 5 to 50 μm in case of the charge transferring layer. The order of lamination is not specifically limited.

Specifically, in this invention, organic photoreceptors disclosed in Japanese Unexamined Patent Publications (Kokai) No. 2005-55870 can be preferably used. Therefore, the written contents of No. 2005-55870 constitute part of the present specifications.

In an image forming, an organic photoreceptor 10 is uniformly charged by a contact charging device 11, and laser beam or the like is irradiated from an exposure device onto the surface of the organic photoreceptor 10 to form an electrostatic latent image. That is, a voltage at a light-irradiated region decreases so as to form an electrostatic latent image. A development device 12 is equipped with a rotatable development sleeve 12a on the opposite side of the organic photoreceptor 10, and a developer (toner) supported on the surface of the development sleeve 12a is stuck onto the electrostatic latent image on the surface of the latent image supporting material drum 10 thereby developing a toner image (visible image formation). That is, the developer in the development device 12 is stirred with a stirring device, friction-charged to the same polarity as the charge polarity of the organic photoreceptor 10 and transported to the development sleeve 12a. The development sleeve 12a is configured with providing a predetermined gap against the organic photoreceptor drum 10, and the developer on the surface of the development sleeve 12a is regulated therewith in its layer thickness by a regulation blade to achieve the predetermined layer thickness. Then, a development bias is applied to the development sleeve 12a so as to adhere the charged toner onto the region having a decreased voltage by the above-described image exposure and form a toner image on the surface of the organic photoreceptor drum 10. A transfer voltage is applied to a transfer material 16 fed/delivered by a contact transfer roller 14, and the toner image on the organic photoreceptor 10 is transferred onto the transfer material 16. The residual toner on the organic photoreceptor 10 is removed and collected by a cleaning blade 15a.

Hereinafter, the present invention will be described in detail by way of Examples and Comparative Examples, however, the present invention is not limited to the following Examples. While the toner is used as a magnetic one-component developer in the following Examples, a two-component developer comprising two components of a toner and a carrier can also be used without problems in the present invention.

### EXAMPLES

### Example 1

### (Production of Toner)

49 Parts by mass of a styrene-acryl copolymer as a binder resin, 45 parts by mass of a magnetic powder (magnetite manufactured by TODA KOGYO CORP.), 3 parts by mass of a quaternary ammonium salt (Bontron P-51: manufactured by ORIENT CHEMICAL INDUSTRIES LTD.) as a positive charge controlling agent and 3 parts by mass of Fisher-Tropsch wax (H1: manufactured by SASOL LTD.) as a release agent were mixed using a Henschell mixer, kneaded by a biaxial extruder, cooled and coarsely ground by a hammer mill. The ground mixed powder was then finely ground using a mechanical grinder, followed by classification using an airflow classifier to prepare a magnetic toner having a volume average particle size of 8.0 μm.

Then, 1.0 part by mass of silica surface treated with a cyclic silazane (TG-820 manufactured by CABOT SPECIALTY CHEMICALS INC.) and 2.0 parts by mass of titanium oxide (EC-100 manufactured by TITAN KOGYO KK) were added to 100 parts by mass of the toner particles, followed by mixed using a Henschell mixer to prepare a toner of the present invention.

### (Production of Photoreceptor)

As an organic photoreceptor, the single-layered type organic photoreceptor described in Example 1 of Japanese Unexamined Patent Publication (Kokai) No. 2005-55870 was produced. Specifically, 20 parts by mass of “ET-1” expressed with a formula (1) as a 1st electronic transferring material, 15 parts by mass of “ET′-3” expressed with a formula (3) as a 2nd electronic transferring material, 50 parts by mass of a stilbene derivative expressed with a formula (14) as a hole transferring material, 2.7 parts by mass of X type non-metal phthalocyanine (CG 1-1) expressed with a formula (7) as a charge generating material, 100 parts by mass of polycarbonate resin expressed in a formula (15) as a binder resin were added to 800 parts by mass of tetrahydrofuran as a solvent.

Subsequently, mixed dispersion was carried out for 50 hours with a ball mill to obtain an application liquid for the single-layered type photosensitive layer.

After applying the obtained application liquid by the dip coat method on an electrocunductive substrate (aluminum tube), hot-air drying was carried out under the condition for 30 minutes at 100° C. to obtain the photoreceptor which has the single-layered type photosensitive layer of 25 μm thickness.

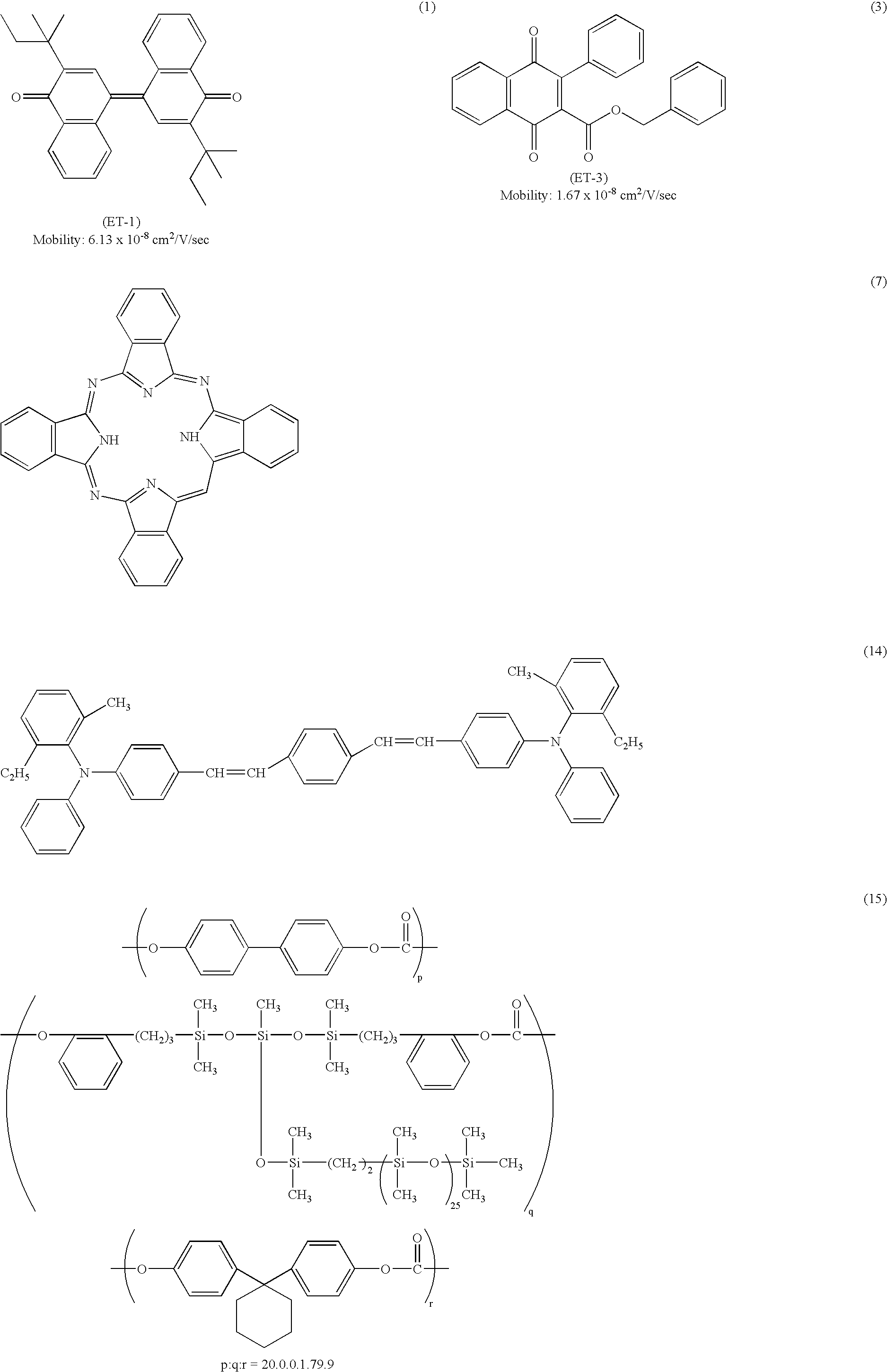

### (Measurement of Toner Particle Size)

The volume average particle size of the toner particles was measured by using Multisizer 3 (trade name) as a coulter counter manufactured by BECKMAN-COULTER INC. The particle distribution of the toner particles was measured using an aperture tube of 100 μm, and the volume average particle size was obtained from the toner volume.

### (Measurement of Silica Particle Size)

The aggregate particle size of silica was measured by taking a micrograph of the toner particle surface magnified 30,000 times using SEM (scanning electron microscope: JSM-880 manufactured by JEOL LTD.), further magnifying the magnified micrograph if necessary, and measuring the number average particle size of any given 100 particles using a scale, a vernier caliper and the like.

### (Measurement of Friction Coefficient)

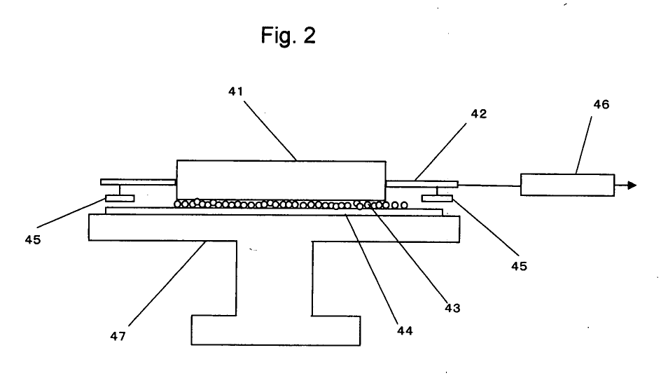

The friction coefficient between a photoreceptor drum and a toner was measured by the method shown in FIG. 2. First, a powder paper was placed on a flat plate 47, on which two-sided tape 44 was stuck so as to fix a toner 43 on it. Then, a toner 43 containing external addition agents of titanium oxide and silica was applied on the two-sided tape 44, and air was blown over the toner so as to make the layer of the toner 43 to be in a more uniform and single-layered state.

Then, a photoreceptor drum tube 41 was placed on the toner 43 spread on the two-sided tape 44. A spring balance 46 was hooked on one end of the shaft 42 extended from the tube 41 and pulled at a constant rate, and thus the value shown by the spring balance 46 was read to measure the frictional force. The rate for pulling the spring balance 46 was 0.1 to 0.3 m/sec. Incidentally, weights 45 were hung from the both ends of the shaft 42 of the photoreceptor drum tube 41, load was applied by increasing the weight, and the friction force was measured every time load was applied.

The weight 45 was varied within a range from 200 to 500 g, and the obtained results were averaged thereby calculating a friction coefficient.

The friction coefficient between the photoreceptor drum and silica were measured in the same manner as in case of the above photoreceptor and the toner, except that only silica was spread on the two-sided tape 44.

### Examples 2 to 7, Comparative Examples 1 to 6

In the same manner as in Example 1, except that the combination shown in Table 1 was employed, a toner was prepared. As aminosilane in Comparative Example 1, “KB903” manufactured by Shin-Etsu Chemical Co., Ltd. was used.

TABLE 1

| | | | Silica | | | |
|---|---|---|---|---|---|---|
| | | | Mean Aggregate | Standard | | Additive |
| | Friction | Friction | Particle Size | Deviation | Surface | Amount |
| | Coefficient (a)¹⁾ | Coefficient (b)²⁾ | [nm] | [nm] | Treatment | [mass %] |
| Example 1 | 0.45 | 0.55 | 100 | 40 | C.S.³⁾ | 1.0 |
| Example 2 | 0.35 | 0.45 | 180 | 40 | C.S. | 1.0 |
| Example 3 | 0.60 | 0.70 | 40 | 40 | C.S. | 1.0 |
| Example 4 | 0.55 | 0.65 | 100 | 60 | C.S. | 1.0 |
| Example 5 | 0.35 | 0.45 | 100 | 25 | C.S. | 1.0 |
| Example 6 | 0.60 | 0.70 | 100 | 40 | C.S. | 2.0 |
| Example 7 | 0.35 | 0.45 | 100 | 40 | C.S. | 0.6 |
| Comp. | 0.75 | 0.85 | 100 | 40 | A.S.⁴⁾ | 1.0 |
| Example 1 | | | | | | |
| Comp. | 0.28 | 0.38 | 220 | 40 | C.S. | 1.0 |
| Example 2 | | | | | | |
| Comp. | 0.70 | 0.80 | 20 | 40 | C.S. | 1.0 |
| Example 3 | | | | | | |
| Comp. | 0.70 | 0.80 | 100 | 70 | C.S. | 1.0 |
| Example 4 | | | | | | |
| Comp. | 0.77 | 0.87 | 100 | 40 | C.S. | 3.0 |
| Example 5 | | | | | | |
| Comp. | 0.27 | 0.37 | 100 | 40 | C.S. | 0.2 |
| Example 6 | | | | | | |

¹⁾Friction coefficient (a) measured between photoreceptor drum and toner.
²⁾Friction coefficient (b) measured between photoreceptor drum and silica.
³⁾C.S: Cyclic Silazane
⁴⁾A.S.: Aminosilane

### (Evaluation Test and Evaluation Method)

Using toners produced in Examples and Comparative Examples, evaluation test for image characteristics was conducted in the initial stage and after 300,000 sheets were printed using a printer (FS-1030D) manufactured by KYOCERA MITA CORP., that an organic photoreceptor drum was loaded.

Under the environment of a room temperature and humidity (20° C., 65% RH), an image evaluation pattern was first printed with the page printer to have an initial image, then 300,000 sheets were printed in continuity (coverage rate of approx. 5%), and an image evaluation pattern was printed once again to evaluate the image after continuous printing.

The images were evaluated with respect to the characteristics of image density, fog and dash mark. The evaluation method and criteria are as follows.

The evaluation of image density (ID) was conducted by measuring a full color solid image using a Macbeth reflection densitometer (RD914). The evaluation was conducted according to the following evaluation criteria. The case where ID is 1.30 or more was rated “∘”, the case where ID is 1.2 or more and less than 1.3 was rated “Δ”, and the case where ID is less than 1.2 was rated “x”, respectively.

Fog density (FD) was measured by a reflection densitometer (TC-6D manufactured by TOKYO DENSHOKU CO. LTD.) for evaluation. The evaluation was conducted according to the following evaluation criteria. The case where FD is 0.010 or less was rated “∘”, the case where FD is 0.011 or more and less than 0.020 was rated “Δ”, and the case where FD is 0.020 or more was rated “x”, respectively.

Dash mark was measured by visual observation. The evaluation was conducted according to the following evaluation criteria. The case where no toner component adhered onto the drum surface and no image defect was observed was rated “∘”, the case where a toner component adhered onto the drum surface, but exerted no adverse influence on the image was rated “Δ”, and the case where a toner component adhered onto the drum surface, and exerted an adverse influence on the image was rated “x”, respectively.

The evaluation result was shown in Table 2.

TABLE 2

| | Image Density | | Fog | | Dash Mark | |
|---|---|---|---|---|---|---|
| | Initial | After 300,000 | Initial | After 300,000 | Initial | After 300,000 |
| Example 1 | ◯ | ◯ | ◯ | ◯ | ◯ | ◯ |
| Example 2 | ◯ | ◯ | ◯ | ◯ | ◯ | ◯ |
| Example 3 | ◯ | ◯ | ◯ | ◯ | ◯ | ◯ |
| Example 4 | ◯ | ◯ | ◯ | ◯ | ◯ | ◯ |
| Example 5 | ◯ | ◯ | ◯ | ◯ | ◯ | ◯ |
| Example 6 | ◯ | ◯ | ◯ | ◯ | ◯ | ◯ |
| Example 7 | ◯ | ◯ | ◯ | ◯ | ◯ | ◯ |
| Comp. Example 1 | Δ | Printing Stop | ◯ | Printing Stop | ◯ | Printing Stop |
| Comp. Example 2 | Δ | X | ◯ | Δ | ◯ | Δ |
| Comp. Example 3 | ◯ | Printing Stop | ◯ | Printing Stop | ◯ | Printing Stop |
| Comp. Example 4 | ◯ | Printing Stop | ◯ | Printing Stop | ◯ | Printing Stop |
| Comp. Example 5 | Δ | Printing Stop | Δ | Printing Stop | ◯ | Printing Stop |
| Comp. Example 6 | ◯ | X | Δ | X | ◯ | Δ |

Note)
“Printing Stop” indicates the examples wherein the printing was stopped because of evaluation as “X” in printing of 6,000 to 12,000 sheets.

As shown in Table 1 and 2, in Comparative Example 1 wherein silica was surface treated with aminosilane, the friction coefficient increased and the image deteriorated when the number of sheets during continuous printing exceeds 10,000.

In the Comparative Example 2 wherein the aggregate particle size of silica was large, the friction coefficient decreased and therefore the polishing effect was considered to deteriorate, thereby causing easy occurrence of a dash mark. In addition, as continuous printing lingered, the image density decreased and the fog deteriorated.

In Comparative Example 3 wherein the aggregate particle size of silica was small, the friction coefficient increased so as to deteriorate the image when the number of sheets during continuous printing is about 5,000.

In Comparative Example 4 wherein the standard deviation of silica particle size distribution was large, the image deteriorated when 10,000 sheets were printed. This was considered because the ratio of silica having small particle size increased and therefore the friction coefficient increased and the toner was likely to adhere.

In Comparative Example 5 wherein a large amount of silica was added, the friction coefficient decreased and the image deteriorated when the number of sheets during continuous printing is about 5,000. The amount of silica added was so much that the toner charge decreased, resulting in decreased image density from the beginning of printing and easy occurrence of fog.

In Comparative Example 6 wherein a small amount of silica was added, the coverage for the toner particles decreased and thus the toner charge was overcharged, causing charge up and inviting decreased image density and fog deterioration. In addition, fluidity of the toner decreased and the friction coefficient increased thereby, resulting in accumulation of the toner at the cleaning blade region. Accordingly, it is considered that the probability of passing through the blade increased and the toner was likely to adhere.

On the other hand, In Examples 1 to 7 wherein the friction coefficient was fallen into a range of the present invention, favorable image density was maintained in the initial stage and even after printing 300,000 sheets, no fog and dash mark occurred and provision of favorable images was confirmed.

While the invention has been described in connection with the preferred embodiment, it is not intended to limit the scope of the invention to the particular form set forth, but, on the contrary, it is intended to cover such alternatives and modifications as may be included within the spirit and scope of the invention as defined by the appended claims. For example, the external addition agent is not restricted to silica and the organic photoreceptor is not restricted to those described in Examples, but any external addition agents, toners and organic photoreceptors conventionally known by those skilled in the art can be used.

What is claimed is:

1. A toner used for an image forming apparatus, comprising an organic photoreceptor as a latent image supporting material and a cleaning blade for removing a residual toner on the organic photoreceptor after a transfer process, wherein a friction coefficient between the organic photoreceptor and the toner is from 0.30 to 0.65.

2. The toner according to claim 1, wherein at least one kind of inorganic fine particles are contained on the toner surface, and one kind of the inorganic fine particles is silica.

3. The toner according to claim 2, wherein the silica is treated with a cyclic silazane.

4. The toner according to claim 2, wherein the silica comprises aggregated particles, whose the average aggregate size is from 30 to 200 nm and the standard deviation of the particle size distribution is 65 nm or less.

5. The toner according to claim 2, wherein the friction coefficient between the silica and the organic photoreceptor is from 0.40 to 0.75.

6. The toner according to claim 2, wherein the amount of the silica added is from 0.5 to 2.5% by mass based on that of the toner.

7. The toner according to claim 1, wherein the toner is a magnetic one-component developer.

8. An image forming apparatus comprising an organic photoreceptor as a latent image supporting material and a cleaning blade for removing a residual toner on the organic photoreceptor after a transfer process, wherein the toner according to claim 1 is used.
